(19) United States
(12) Patent Application Publication
(10) Pub. No.: US 2003/0007659 A1
(43) Pub. Date: Jan. 9, 2003

(54) Acoustic element

(75) Inventor: Kari Kirjavainen, Tampere (FI)

Correspondence Address: MARSHALL, GERSTEIN & BORUN, 6300 SEARS TOWER, 233 SOUTH WACKER, CHICAGO, IL, 60606-6357, US

(73) Assignee: Panphonics OY, ESPOO (FI)

(21) Appl. No.: 10/137,968

(22) Filed: May 3, 2002

Related U.S. Application Data
(63) Continuation of application No. PCT/FI00/00967, filed on Nov. 6, 2000.

(30) Foreign Application Priority Data
Nov. 5, 1999 (FI) 19992397

(51) Int. Cl. H04R 1/02; H04R 1/20

(52) U.S. Cl. 381/338

(57) ABSTRACT

An acoustic element comprising a platelike active element. The platelike active element comprises creases. The creases can be produced such that the platelike active element forms a space comprising at least one opening and/or gap, whereby the space and the opening and/or the gap constitute a Hemholz resonator.

This application is a Continuation of International Application PCT/FI00/00967 filed on Nov. 6, 2000, which designated the U.S. and was published under PCT Article 21(2) in English.

The invention relates to an acoustic element comprising at least one platelike active element, which platelike active element per se is capable of producing acoustic pressure.

FI Publication 960 861 discloses an acoustic element made of a porous stator sheet, which is either electrically conductive or provided with an electrically conductive coating on at least one of its surfaces. A moving film is attached to the stator sheet. The acoustic element is simple and effective. Furthermore, the structure of the acoustic element is flat, which makes the element versatile. In some applications, however, it would be desirable to achieve a slightly better frequency response and further, in some cases, the acoustic element has to be quite large in order to achieve a sufficiently high output power.

FI Publication 104 611 discloses a power transformer comprising a film with electrodes arranged therein. The film and the electrodes per se do not produce acoustic pressure. The film together with its electrodes has, however, been folded such that the control electrodes in the film are located on different sides of successive folds. In the successive folds, the strength of the electric field is varied using a control voltage, which makes the successive folds to move. Such a folded element then operates as an active element, i.e. it produces acoustic pressure. Such a folded element is, however, relatively thick, and in some cases it would be necessary to produce a higher output power.

An object of the present invention is to provide a versatile acoustic element with good properties.

The acoustic element of the invention is characterized in that the platelike active element comprises creases.

The idea underlying the invention is that the acoustic element comprises a platelike active element comprising creases. The idea of a preferred embodiment is that the creases are produced such that the platelike active element forms a space comprising at least one opening and/or gap, whereby the space and the opening and/or the gap constitute a Hemholz resonator.

An advantage of the invention is that the acoustic element is capable of producing an extremely high output power. Furthermore, the acoustic element can be made stiff and it is capable of producing high absorption. Furthermore, the acoustic element can be given a substantially curved shape having a desired radius of curvature. The mass of substantially the entire acoustic element can be arranged to produce output power. The creases also add liveliness to the surface structure of the acoustic element. By rendering the acoustic element curved, its radiation angle can be enhanced and it can be arranged e.g. inside a ventilation pipe in active noise reduction applications without separate additional constructions. When the acoustic element is formed such that it comprises one or more Hemholz resonators, the proportion of low frequencies produced by the acoustic element can be increased. Furthermore, the acoustic response of the element can thus be adjusted and the passive absorption capacity of the element be improved at the low frequencies in particular.

The invention will be described in closer detail in the accompanying drawings, in which

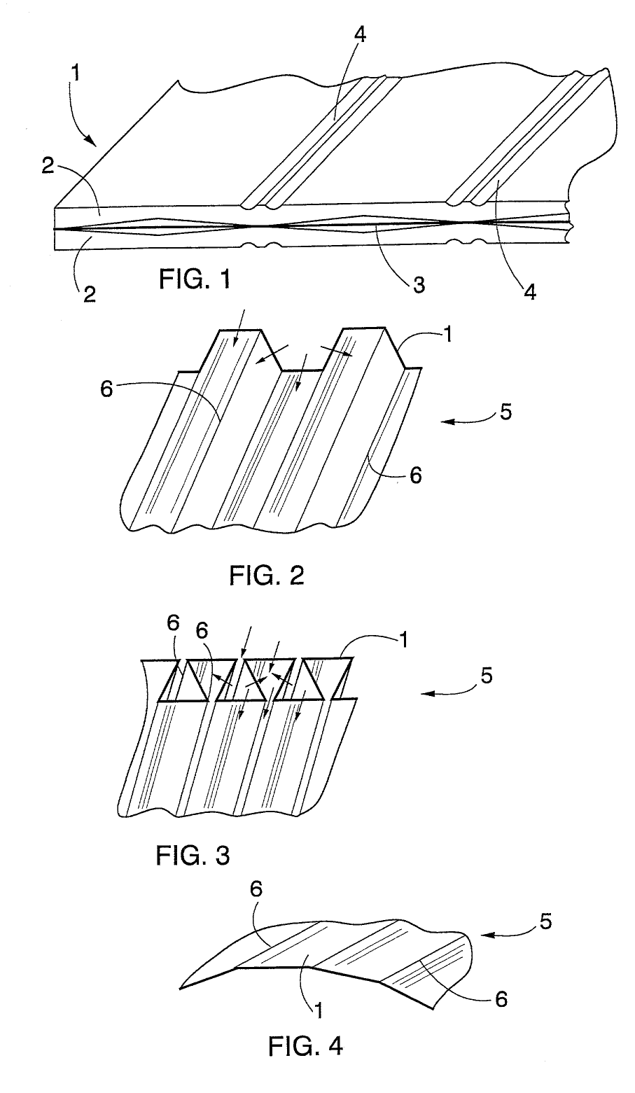

FIG. 1 schematically shows a platelike active element,

FIGS. 2 to 4 are schematic axonometric views of acoustic elements of the invention,

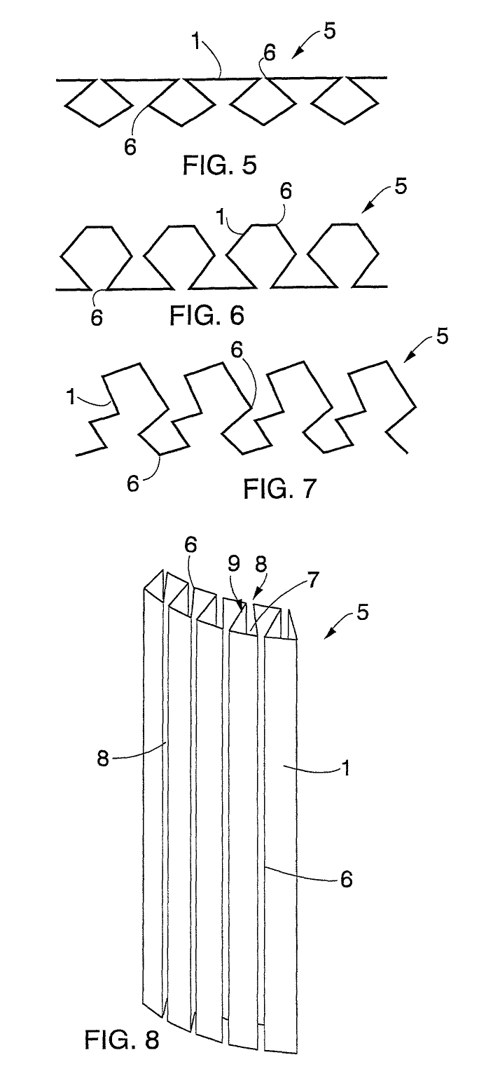

FIGS. 5 to 7 are schematic views of the cross-sectional shapes of acoustic elements of the invention,

FIG. 8 is a schematic axonometric view of an acoustic element of the invention,

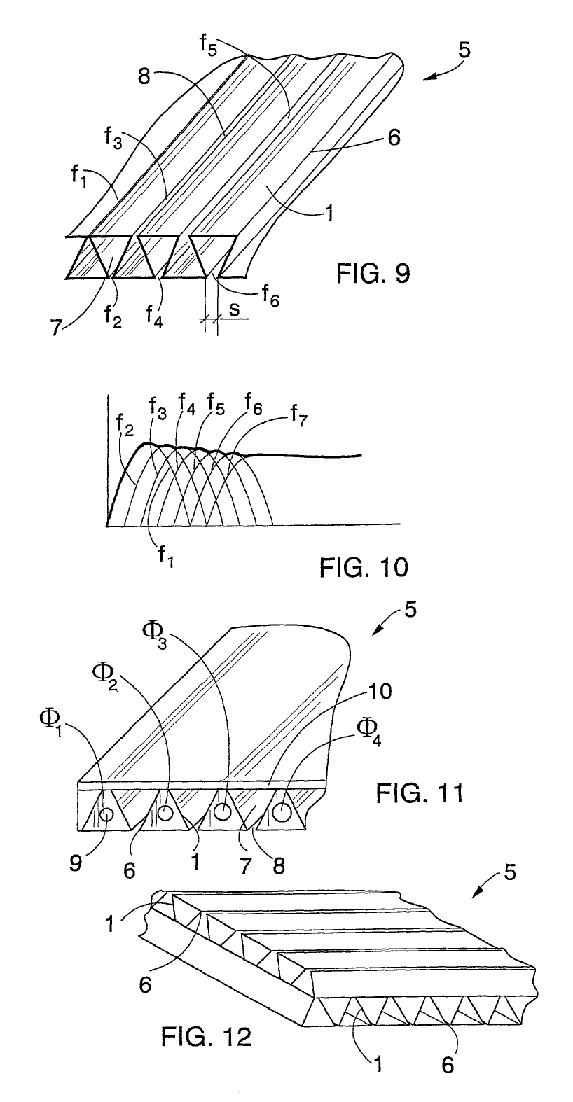

FIG. 9 is a schematic axonometric view of still another acoustic element of the invention,

FIG. 10 schematically shows a frequency response of the acoustic element according to FIG. 9,

FIG. 11 is a schematic axonometric view of still another acoustic element of the invention, and

FIG. 12 is an axonometric view of still another acoustic element of the invention.

FIG. 1 shows a platelike active element. The platelike active element of FIG. 1 comprises two porous stator sheets 2 with a moving film 3 arranged therebetween. The porous stator sheets 2 are either electrically conductive or they are provided with an electrically conductive coating on at least one of their surfaces. The moving film 3 comprises at least one electrically conductive surface and the moving film 3 is preferably an electret film which is electrically charged. The platelike active element 1 of FIG. 1 is a dipole sound source, i.e. the element 1 is acoustically transparent, which means that the film 3 moves with an acoustic wave. Consequently, if a positive acoustic pressure prevails on one side of the film 3, the acoustic pressure on the other side is thus negative. The platelike active element may also be e.g. a mono-pole sound source which can change its thickness, as shown e.g. in FI Publication 980 926. The platelike active element 1 must be provided with at least one stator sheet 2 and at least one moving film 3. The basic structure and operation of the platelike active element 1 are not described in closer detail in the accompanying drawings since the solutions are known per se to one skilled in the art. The definition “active element” thus refers to a platelike structure which per se produces acoustic pressure.

The platelike active element 1 is provided with groovings 4. The groovings 4 enable the platelike active element 1 to be bent such that the element is provided with creases.

1 with creases 6. In FIG. 3, the creases are more abrupt than in the solution shown in FIG. 2. Furthermore, arrows in FIGS. 2 and 3 illustrate how the acoustic element 5 produces noise.

FIG. 4 shows an acoustic element 5 wherein the creases 6 form rather slight angles, the shape of the acoustic element 5 being substantially curved. The creases 6 may also form a hinged arrangement to enable the platelike active element 1 to be even rolled up.

FIGS. 5, 6 and 7 illustrate different cross-sectional shapes of the acoustic element 5. The number of creases 6 and the magnitude of the angles thereof may thus range quite a lot.

FIG. 8 shows an acoustic element 5 which is also given a curved shape by means of the creases 6. The angle of radiation of the acoustic element is quite large. Furthermore, the curved acoustic element 5 can be arranged on a round surface, e.g. inside a ventilation pipe, without separate additional structures.

In FIG. 8, the creases 6 are formed such that the platelike active element 1 forms several tubelike spaces 7. The tubelike spaces 7 are provided with an elongated gap 8. Furthermore, an end of a tubelike space may be closed or it may be provided with an opening 9. The tubelike space 7 as well as the gap 8 and/or the opening 9 are dimensioned such that when the acoustic element 1 is used, resonance is produced therein at a low frequency, e.g. at a frequency of about 50 Hz. The structure is thus a Hemholz resonator. The gaps 8 inside and also the gaps 8 outside the curvature centre of the curved acoustic element 5 can be formed such that resonance is produced at low frequencies.

FIG. 9 shows a solution wherein the gaps 8 in conjunction with the different tubelike spaces 7 differ in width. Each space 7 and each gap 8 is then tuned to produce resonance at a different frequency, the frequencies being illustrated in the figure by designations f₁ to f₆. The narrower the gap 8, the lower the frequency to which the Hemholz resonator tunes. If, e.g. in the case of FIG. 9, one side of the substantially triangular cross-sectional structure of the tubelike space 7 in the acoustic element is e.g. about 3 cm long, the width s of the gap 8 varies e.g. between 0.5 to 3 mm.

A first resonator may be tuned to a frequency f₁=20 Hz, a second to a frequency f₂=25 Hz, a third to a frequency f₃=30 Hz, a fourth to a frequency f₄=35 Hz, a fifth to a frequency f₅=40 Hz, and a sixth to a frequency f₆=45 Hz. Frequencies higher than this, in turn, are formed within a straight section of the tubelike space 7 by the platelike active element 1. FIG. 10 shows the frequency response of the acoustic element 5 according to FIG. 9. The frequency response of each Hemholz resonator is designated by a line equipped with designations f₁ to f₆, and the frequency response of the platelike active element 1 by designation f₇. The frequency response of the acoustic element 5, on the other hand, is designated by a thicker line in FIG. 10. The Hemholz resonators thus enable the proportion of low frequencies to be increased and, all in all, the acoustic response of the acoustic element 5 to be tuned extremely well.

FIG. 11 shows a solution wherein the acoustic element 5 comprises a plate 10 to close every other gap 8 of the tubelike space. Then, by dimensioning diameter φ₁ to φ₄ of the openings 9 of the spaces 7 appropriately, the Hemholz resonator can be tuned to a desired frequency. The opening 9 may be located at either end or at both ends of the tubelike space. If the plate 10 is arranged only on one side of the acoustic element 5, every other tubelike space is provided with a gap 8, and by choosing the width of the gap appropriately, the Hemholz resonator can be tuned to a suitable frequency. Instead of using the plate 10, the platelike active element 1 can be creased such that no gaps 8 will be produced.

FIG. 12 shows a solution wherein the acoustic element 5 comprises two platelike active elements 1 equipped with creases 6 and arranged on top of each other such that the lines of the creases 6 in the platelike active elements on top of each other are substantially divergent. The structure of the acoustic element can thus be rendered particularly stiff.

The drawings and the related description are only intended to illustrate the idea of the invention. In its details, the invention may vary within the scope of the claims. The acoustic element of the invention can be employed in many applications of sound reproduction and noise reduction. In the noise reduction applications, the acoustic element may be an element either insulating or absorbing sound.

1. An acoustic element comprising at least one platelike active element, which platelike active element is capable of producing acoustic pressure, the platelike active element comprising creases that are arranged such that the platelike active element forms a space comprising at least one of an opening and a gap, whereby the space and the one of the opening and the gap constitute a Hemholz resonator.

2. An acoustic element as claimed in claim 1, wherein the acoustic element comprises at least two Hemholz resonators such that different resonators are tuned to different frequencies.

3. An acoustic element as claimed in claim 1, wherein the creases are formed such that the acoustic element is substantially curved.

4. An acoustic element as claimed in claim 1, wherein the acoustic element comprises at least two platelike active elements comprising creases, and the platelike active elements are arranged on top of each other such that the lines of the creases therein are substantially divergent.

5. An acoustic element as claimed in claim 1, wherein the acoustic element comprises at least one stator sheet and at least one moving film.

6. An acoustic element as claimed in claim 5, wherein at least one stator sheet is a porous stator sheet which is electrically conductive and at least one moving film comprises at least one electrically conductive surface.

7. An acoustic element as claimed in claim 5, wherein at least one stator sheet is a porous stator sheet which is provided with an electrically conductive coating on at least one of its surfaces.

8. An acoustic element as claimed in claim 5, wherein the moving film is permanently charged as an electret film.

9. An acoustic element as claimed in claim 6, wherein the moving film is permanently charged as an electret film.

10. An acoustic element as claimed in claim 7, wherein the moving film is permanently changed as an electrical film.
